(19) United States
(12) Patent Application Publication
(10) Pub. No.: US 2020/0312173 A1
(43) Pub. Date: Oct. 1, 2020

(54) DISPLAY SYSTEM, DISPLAY METHOD, PROGRAM, AND RECORDING MEDIUM

(71) Applicant: NEC Solution Innovators, Ltd., Koto-ku, Tokyo (JP)

(72) Inventors: Masakazu MORIGUCHI, Tokyo (JP); Yusuke NAKAO, Tokyo (JP); Yoshie SAKURAZAWA, Tokyo (JP)

(73) Assignee: NEC Solution Innovators, Ltd., Koto-ku, Tokyo (JP)

(21) Appl. No.: 16/308,877

(22) PCT Filed: Jan. 31, 2017
(86) PCT No.: PCT/JP2017/003352

§ 371 Date: Dec. 11, 2018

(30) Foreign Application Priority Data
Jun. 17, 2016 (JP) 2016-121106

(51) Int. Cl. G09B 5/02; G09B 19/00

(52) U.S. Cl. CPC G09B 5/02; G09B 15/00; G09B 19/003

(57) ABSTRACT

The present invention provides a new display system, display method, program, and recording medium that can easily learn the motion of a target over time. A display system 10 of the present invention includes: a storage unit 11 containing motion information of a target over time; an acquisition unit 121 that acquires predetermined n types of motions Xₙ and execution times T_{Xn} of the motions Xₙ in a time axis from the motion information of the target over time; a conversion unit 122 that converts the motion Xₙ into a corresponding marker xₙ; a note creation unit 123 that creates a note in which the marker xₙ is placed at the execution time T_{Xn} in the time axis; and a display unit 13 that displays the note.

### TECHNICAL FIELD

The present invention relates to a display system, a display method, a program, and a recording medium.

### BACKGROUND ART

When a novice learns the motion of a skilled person in a factory, he or she actually observes the work or the like of the skilled person in the factory and learns by mimicking it. Application of such motion learning is not limited to a factory, and the same applies to learning of a motion of playing a musical instrument such as a piano, a guitar, or the like, learning of a motion of a sport such as soccer, or the like.

### SUMMARY OF INVENTION

### Technical Problem

However, when a novice learns the work of a skilled person by mimicking it, for example, the skilled person has a knack for each motion whereas the novice does not have a knack for each motion. For this reason, there is a problem that it takes time for a novice to newly acquire the work.

Hence, the present invention is intended to provide a new display system, display method, program, and recording medium that can easily learn the motion of a target over time.

### Solution to Problem

In order to achieve the above object, the present invention provides a display system including: a storage unit containing motion information of a target over time; an acquisition unit that acquires predetermined n types of motions Xₙ and execution times T_{Xn} of the motions Xₙ in a time axis from the motion information of the target over time; a conversion unit that converts the motion Xₙ into a corresponding marker xₙ; a note creation unit that creates a note in which the marker xₙ is placed at the execution time T_{Xn} in the time axis; and a display unit that displays the note.

The present invention also provides a display method using motion information of a target over time, including the steps of: acquiring predetermined n types of motions Xₙ and execution times T_{Xn} of the motions Xₙ in a time axis from the motion information of the target over time; converting the motion Xₙ into a corresponding marker xₙ; creating a note in which the marker xₙ is placed at the execution time T_{Xn} in the time axis; and displaying the note.

The present invention also provides a program that can execute the display method of the present invention on a computer.

The present invention also provides a computer-readable recording medium recorded with the program of the present invention.

### Advantageous Effects of Invention

According to the present invention, the motion of a target over time can be learned easily.

### BRIEF DESCRIPTION OF DRAWINGS

FIG. 1 is a block diagram showing an example (first example embodiment) of the display system of the present invention.

FIG. 2 is a flowchart showing an example (first example embodiment) of the display method of the present invention.

FIG. 3 is a block diagram showing an example (second example embodiment) of the display system of the present invention.

FIG. 4 is a flowchart showing an example (second example embodiment) of the display method of the present invention.

FIGS. 5A to 5C are views each showing an example (third example embodiment) of the display screen of the display system of the present invention.

FIG. 6 is a block diagram showing an example (fifth example embodiment) of the display system of the present invention.

### DESCRIPTION OF EMBODIMENTS

In the display system and display method of the present invention, for example, the motion information of the target over time is motion data of the target.

The display system of the present invention further includes an analysis unit that analyzes the predetermined n types of motions Xₙ and the execution times T_{Xn} of the motions Xₙ in the time axis with reference to the motion data of the target, wherein the acquisition unit acquires the predetermined n types of motions Xₙ and the execution times T_{Xn} analyzed by the analysis unit, for example.

In the display system and display method of the present invention, for example, the motion information of the target over time includes the predetermined n types of motions Xₙ and the execution times T_{Xn}.

The display system of the present invention further includes, for example, a correction unit that corrects at least one selected from the group consisting of the number of markers xₙ, an interval between the markers xₙ, and a shape of the marker xₙ in the note.

In the display system of the present invention, for example, the display unit moves the note along the time axis and displays the marker xₙ at a predetermined position in the execution time T_{Xn}.

The display system of the present invention further includes, for example, a movement control unit that controls movement of the note in the display unit based on acquired motion information of a user.

The display method of the present invention further includes, for example, the step of: analyzing the predetermined n types of motions Xₙ and the execution times T_{Xn} of the motions Xₙ in the time axis with reference to the motion data of the target, wherein the predetermined n types of motions Xₙ and the execution times T_{Xn} analyzed in the analysis step are acquired in the acquisition step.

The display method of the present invention further includes, for example, the step of: correcting at least one selected from the group consisting of the number of markers xₙ, an interval between the markers xₙ, and a shape of the marker xₙ in the note.

In the display method of the present invention, for example, the note is moved along the time axis, and the marker xₙ is displayed at a predetermined position in the execution time T_{Xn} in the display step.

The display method of the present invention further includes, for example, the step of: controlling movement of the note in the display step based on acquired motion information of a user.

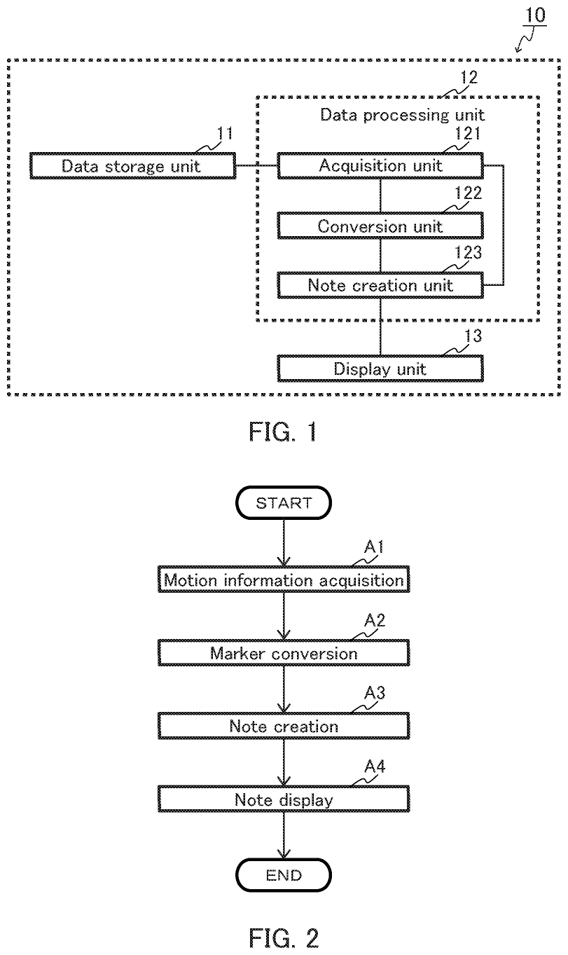

The example embodiments of the present invention are described below. It is to be noted, however, that the present invention is by no means limited or restricted by the following example embodiments. In the following FIGS. 1 to 6, identical parts are indicated with identical reference signs. Regarding the descriptions of the example embodiments, reference can be made to one another unless otherwise stated. Furthermore, the configurations of the example embodiments can be combined unless otherwise stated.

### First Embodiment

The first example embodiment relates to a display system and a display method of the present invention.

FIG. 1 shows a block diagram of a display system according to the present example embodiment. As shown in FIG. 1, a display system 10 of the present example embodiment includes a data storage unit 11, an acquisition unit 121, a conversion unit 122, a note creation unit 123, and a display unit 13. The acquisition unit 121, the conversion unit 122, and the note creation unit 123 may be installed, as shown in FIG. 1, for example, in a data processing unit (data processing device) 12, which is hardware or may be software or hardware in which the software is installed. The data processing unit 12 may include a central processing unit (CPU) or the like. In the display system 10 of the present example embodiment, the data storage unit 11 is electrically connected to the acquisition unit 121, the acquisition unit 121 is electrically connected to the conversion unit 122 and the note creation unit 123, the conversion unit 122 is electrically connected to the note creation unit 123, and the note creation unit 123 is electrically connected to the display unit 13. The display system 10 of the present example embodiment includes the data storage unit 11, the acquisition unit 121, the conversion unit 122, the note creation unit 123, and the display unit 13 combined in one, and therefore can be referred to as a display apparatus, for example. Any one or more units may be separated from the display system 10 of the present example embodiment, for example, as described below.

The data storage unit 11 contains motion information of a target over time. Examples of the data storage unit 11 include random access memories (RAMs), read-only memories (ROMs), flash memories, hard disks (HDs), optical disks, and floppy disks (FDs). The data storage unit 11 may be a built-in type or an external type such as an external storage device. The target is not particularly limited, and is, for example, a target whose motion is to be learned using the display system 10. The target may be any target. In the case of learning a motion of factory work, the target may be, for example, a skilled worker in the factory work. In the case of learning a motion of playing a musical instrument, the target may be, for example, a professional musician, a musical instructor, or the like. In the case of learning a motion of a sport, the target may be, for example, an athlete, a sport instructor, or the like. Examples of the motion include movements of the body of the target, movements of the living body of the target such as a pulse, a heartbeat, and the like, and lines of sight. The motion information of the target over time is, for example, information including information on the motion of the target and information on the time of the motion, and specifically is, for example, information including the motion data of the target, the predetermined n types of motions Xₙ, and the execution times T_{Xn} of the motions Xₙ described below. Examples of the motion data of the target include motion images such as two-dimensional or three-dimensional images, two-dimensional or three-dimensional motion sensor data acquired by a sensor or the like, and motion analysis data analyzed by a motion analysis table or the like. The motion information of the target over time may further include, for example, body shape information, attribute information, and the like of the target. The body shape information may include, for example, the height and the like of the target. The attribute information may include, for example, the age, sex, and the like of the target.

The acquisition unit 121 acquires predetermined n types of motions Xₙ and execution times T_{Xn} of the motions Xₙ in the time axis from the motion information of the target over time. The acquisition unit 121 may be, for example, the CPU or the like. The time axis is, for example, a time axis in the motion information of the target over time. Specifically, the time axis may be a time axis in the motion data of the target. The predetermined n types of motions Xₙ are not particularly limited, and are, for example, motions of a target to be learned using the display system 10, and can be appropriately set depending on the target. As a specific example, in the case of learning a motion of a skilled worker in a factory, the predetermined n types of motions Xₙ include, for example, grasping an object, releasing an object, applying a label, pressing a button, and the like. The motion information of the target over time may include, for example, a plurality of motions Xₙ. In this case, the motion information of the target over time includes the execution times T_{Xα} of the plurality of motions X_{α}. The number of “n” in the n types of motions Xₙ is not particularly limited, and can be appropriately set according to, for example, the motion information of the target over time. The “n” is an integer of 1 or more, and may be 2 or more. Examples of the execution time T_{Xn} of the motion Xₙ include a start time of the motion Xₙ, an end time of the motion Xₙ, a time from the start to the end of the motion Xₙ, and a time when the motion Xₙ is actually performed (e.g., date and time) in the time axis.

The conversion unit 122 converts the motion Xₙ into a corresponding marker xₙ. The conversion unit 122 may be, for example, the CPU or the like. The marker xₙ is not particularly limited, and can be any marker, for example.

The note creation unit 123 creates a note in which the marker xₙ is placed at the execution time T_{Xn} in the time axis. The note creation unit 123 may be, for example, the CPU.

The display unit 13 displays the note. Examples of the display unit 13 include monitors (e.g., various image display apparatuses such as liquid crystal displays (LCDs), cathode ray tube (CRT) displays, and the like) for outputting images. The display unit 13 may be, for example, a display worn on the body. Specifically, the display unit 13 may be, for example, a head mounted display or the like.

In the display system of the present example embodiment, the motion information of the target over time acquired from the data storage unit 11, the information on the marker xₙ converted from the motion Xₙ, and the information of the note are stored in the acquisition unit 121, the conversion unit 122, and the note creation unit 123, respectively. The present invention is not limited thereto, and each information may be stored in the data storage unit 11 and each of the following units may read each information from the data storage unit 11.

FIG. 2 shows a flowchart of the display method in the present example embodiment. The display method of the present example embodiment is performed as follows using the display system 10 of FIG. 1, for example. As shown in FIG. 2, the display method of the present example embodiment includes a step A1 (motion information acquisition), a step A2 (marker conversion), a step A3 (note creation), and a step A4 (note display).

First, the motion information of the target over time is prepared prior to the step A1. The motion information of the target over time is, for example, information including the predetermined n types of motions Xₙ and the execution times T_{Xn} of the motions Xₙ obtained by analyzing the motion information of the target over time, and this information is stored in the data processing unit 12. The analysis of the motion information of the target over time is described below.

(A1) Motion Information Acquisition

In the step A1, predetermined n types of motions Xₙ and execution times T_{Xn} of the motions Xₙ in the time axis are acquired from the motion information of the target over time. Specifically, in the step A1, for example, the predetermined n types of motions Xₙ and the execution times T_{Xn} of the motions Xₙ stored in the data processing unit 12 are acquired.

(A2) Marker Conversion

In the step A2, the motion Xₙ is converted into a corresponding marker xₙ. Specifically, for example, the user associates the motion Xₙ with the marker xₙ in advance. Then, in the step A2, by referring to the association, each motion Xₙ of the predetermined n types of motions Xₙ acquired in the step A1 is converted into the corresponding marker xₙ. When n is 2 or more, the markers xₙ thereof may be the same or different, and the latter is preferable because the user can easily understand the motions Xₙ corresponding to the markers xₙ and learn them more efficiently.

(A3) Note Creation

In the step A3, a note in which the marker xₙ is placed at the execution time T_{Xn} in the time axis is created. In the step A3, for example, the marker xₙ is placed at the position corresponding to the execution time T_{Xn} in the time axis. The interval between the markers xₙ on the note is not particularly limited as long as the markers xₙ are placed at positions corresponding to the execution times T_{Xn}. In the note, the markers xₙ may be placed on one axis (e.g., a line on the note, a space such as a lane between lines, or the like), or may be placed on two or more axes. In the latter case, for example, each of the markers xₙ may be separately placed for each body part used in the motion of the corresponding motion Xₙ. As a specific example, for example, when the motion X_{α} corresponding to the marker x_{α} is the motion of the right hand, the marker x_{α} is placed on the axis on which the marker relating to the motion of the right hand is placed. On the other hand, when the motion X_{β} corresponding to the marker x_{β} is the motion of the left hand, the marker x_{β} is placed not on the axis on which the marker relating to the motion of the right hand is placed but on the axis on which the marker relating to the motion of the left hand is placed. In this manner, by separately placing the marker xₙ for each body part used in the motion, for example, the user can understand more clearly which part of the body should be moved in learning of the motion. This allows the user to learn the motion more efficiently.

(A4) Note Display

In the step A4, the note is displayed. In the step A4, for example, the whole note may be displayed on the display unit 13, or a part of the note may be displayed on the display unit 13. In the case of displaying a part of the note, for example, the note is moved along the time axis, and the marker xₙ is displayed at a predetermined position (e.g., a position instructing the user to perform the motion Xₙ) in the execution time Txₙ. Specifically, for example, a fixed time range in the note is displayed, and at this time, the starting point of the displayed fixed time range is moved from the start to the end of the note over time.

In the display system and display method of the present example embodiment, the note is created based on the motion information of the target over time and displayed. Therefore, the user can easily learn the motion of the target by performing the motion Xₙ corresponding to the marker xₙ in the note. The same effects as these can be obtained also in the example embodiments described below.

[Variation 1]

Variation 1 relates to a display system and a display method of the present invention. Regarding the display system and the display method of Variation 1, for example, reference can be made to the description as to the display system and the display method of the first example embodiment.

It is preferable that the display system of Variation 1 further includes a correction unit that corrects at least one selected from the group consisting of the number of markers xₙ, the interval between the markers xₙ, and the shape of the marker xₙ in the note. The correction unit may be, for example, a CPU or the like. In the display system of Variation 1, for example, the display unit displays a note in which at least one selected from the group consisting of the number of markers xₙ, the interval between the markers xₙ, and the shape of the marker xₙ in the note is corrected by the correction unit. The shape of the marker xₙ may be, for example, the thickness, size, length, color, or the like of the marker xₙ.

It is preferable that the display method of Variation 1 further includes the step of: correcting at least one selected from the group consisting of the number of markers xₙ, the interval between the markers xₙ, and the shape of the marker xₙ in the note. In the correction step, for example, at least one selected from the group consisting of the number of markers xₙ the interval between the markers xₙ, and the shape of the marker xₙ in the note created in the note creation step is corrected. In the correction step, the target to be corrected may be any one, two, or all of the number of marks xₙ, the interval between the marks xₙ, and the shape of the mark xₙ. In the correction step, for example, the correction may be performed based on a preset criterion, or may be performed based on a criterion set at the time of use by a user or the like. The preset criterion may be, for example, a criterion according to the degree of difficulty of the note. Specifically, in the correction step, the correction may be, for example, reducing the number of the markers xₙ in the note, expanding the interval between the markers xₙ in the note, or both reducing the number of the markers xₙ in the note and expanding the interval between the markers xₙ. Thereby, for example, the degree of difficulty of the note can be lowered. In the display step of the display method of Variation 1, for example, a note in which at least one selected from the group consisting of the number of markers xₙ, the interval between the markers xₙ, and the shape of the marker xₙ in the note is corrected by the correction unit is displayed.

In the display system and display method of Variation 1, for example, at least one selected from the group consisting of the number of markers xₙ, the interval between the markers xₙ, and the shape of the marker xₙ in the note can be corrected, so that, for example, the content of the note can be corrected so as to be suitable for the level of the user, and the note suitable for the level of the user can be displayed. Therefore, for example, the user can learn the motion suitable for his or her level, so that the user can learn the motion more efficiently.

[Variation 2]

Variation 2 relates to a display system and a display method of the present invention. Regarding the display system and the display method of Variation 2, for example, reference can be made to the description as to the display system and the display method of the first example embodiment and Variation 1.

It is preferable that the display system of Variation 2 further includes a movement control unit that controls movement of the note in the display unit based on the acquired motion information of the user. The movement control unit may be, for example, a CPU or the like. The display system of Variation 2 is preferably applied to, for example, a case where a part of the note is displayed by the display unit or a case where the note is moved along the time axis and the marker xₙ is displayed at a predetermined position in the execution time Txₙ. The acquired motion information of the user is, for example, information including information on the motion of the user and information on the time of the motion, and specifically is, for example, information including the motion data of the user, the motion of the user corresponding to the marker xₙ, and the execution time of the motion of the user. The movement of the note may be controlled, for example, by stopping the movement of the note, starting the movement of the note, slowing the moving speed of the note, or accelerating the moving speed of the note.

It is preferable that the display method of Variation 2 further includes the step of: controlling movement of the note in the display step based on the acquired motion information of the user. The display method of Variation 2 is preferably applied to, for example, a case where a part of the note is displayed in the display step or a case where the note is moved along the time axis and the marker xₙ is displayed at a predetermined position in the execution time Txₙ. In the movement control step, for example, information including the motion of the user corresponding to the marker xₙ and the execution time of the motion of the user are acquired, and the execution time Txₙ of the motion Xₙ corresponding to the marker xₙ is compared with the execution time of the motion of the user. In the case where the difference between the execution time Txₙ and the execution time of the motion of the user is within a predetermined range, the moving speed of the note is not changed, for example. On the other hand, in the case where the difference between the execution time Txₙ and the execution time of the motion of the user is out of a predetermined range, for example, when the execution time of the motion of the user is slower than the execution time Txₙ, the movement of the note is stopped or the moving speed of the note is slowed. Also, for example, when the execution time of the motion of the user is faster than the execution time Txₙ, the movement of the note is started or the moving speed of the note is accelerated. The predetermined range can be appropriately set according to, for example, the type of the motion Xₙ, the level of the user, and the like.

In the display system and display method of Variation 2, for example, the movement of the note can be controlled, so that the note can be displayed at the moving speed suitable for the level of the user. Therefore, for example, the user can learn the motion suitable for his or her level, so that the user can learn the motion of the target more efficiently.

### Second Example Embodiment

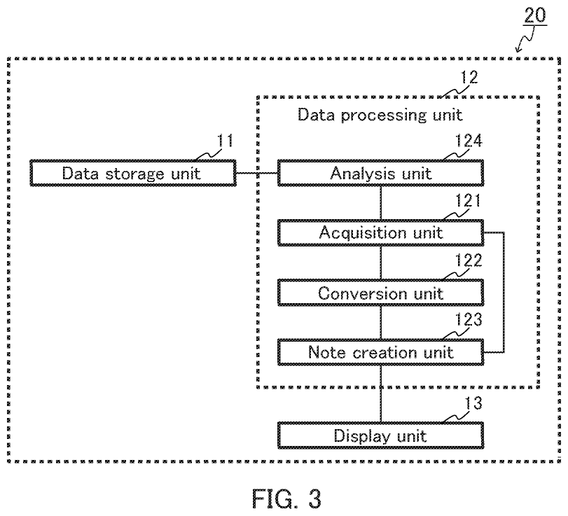

FIG. 3 shows a block diagram of a display system according to the present example embodiment. As shown in FIG. 3, a display system 20 of the present example embodiment includes an analysis unit 124 in addition to the units of the display system 10 of the first example embodiment. As shown in FIG. 3, the analysis unit 124 may be installed in the data processing unit 12. In the display system 20 of the present example embodiment, the data storage unit 11 is electrically connected to the analysis unit 124 instead of the acquisition unit 121, and the analysis unit 124 is electrically connected to the acquisition unit 121. Except for this point, the display system 20 of the present example embodiment has the same configuration as the display system 10 of the first example embodiment, and reference can be made to the description as to the display system 10 of the first example embodiment.

The analysis unit 124 analyzes the predetermined n types of motions Xₙ and the execution times T_{Xn} of the motions Xₙ in the time axis with reference to the motion data of the target. The analysis unit 124 may be, for example, the CPU or the like. The analysis unit 124 acquires the motion data of the target from the data storage unit 11, and analyzes the motion data, for example.

In the display system 20 of the present example embodiment, the analysis result of the motion data of the target, the motion information of the target over time acquired from the analysis unit 124, the information on the marker xₙ converted from the motion Xₙ, and the information of the note are stored in the analysis unit 124, the acquisition unit 121, the conversion unit 122, and the note creation unit 123, respectively. The present invention is not limited thereto, and each information and result may be stored in the data storage unit 11 and each of the following units may read the information from the data storage unit 11.

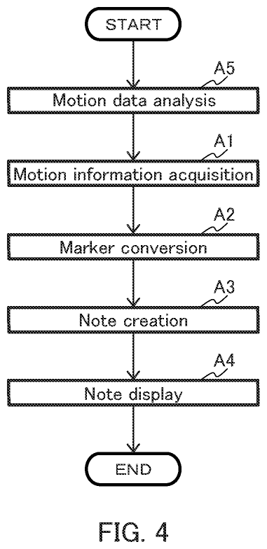

FIG. 4 shows a flowchart of the display method in the present example embodiment. The display method of the present example embodiment is performed as follows, for example, using the display system 20 of FIG. 3. As shown in FIG. 4, the display method of the present example embodiment includes a step A5 (motion data analysis) in addition to the steps of the display method of the first example embodiment, and the predetermined n types of motions Xₙ and the execution times T_{Xn} analyzed in the step A5 are acquired in the step A1. Except for this point, the display method of the present example embodiment has the same configuration as the display method of the first example embodiment, and reference can be made to the description as to the display system of the first example embodiment.

(A5) Motion Data Analysis

In the step A5, the predetermined n types of motions Xₙ and the execution times T_{Xn} of the motions Xₙ in the time axis are analyzed with reference the motion data of the target. Specifically, in the step A5, first, the motion data of the target is acquired from the data storage unit 11. Next, with respect to the motion data of the target, the predetermined n types of motions Xₙ are analyzed by a known motion detection method. Then, the execution times T_{Xn} of the motions Xₙ in the time axis are analyzed. In the case of analyzing information on the motion information, for example, when height information, attribute information, and the like of the target are analyzed, the height information, attribute information, and the like of the target are analyzed by a known video analysis method or attribute analysis method.

(A1) Motion Information Acquisition

In the step A1, the predetermined n types of motions Xₙ and the execution times T_{Xn} analyzed in the step A5 are acquired. Except for this point, reference can be made to the description as to the step A1 in the display method of the first example embodiment.

The steps A2 to A4 in FIG. 4 can be performed in the same manner as in the first example embodiment, specifically, can be performed according to the flowchart of FIG. 2 described above.

### Third Example Embodiment

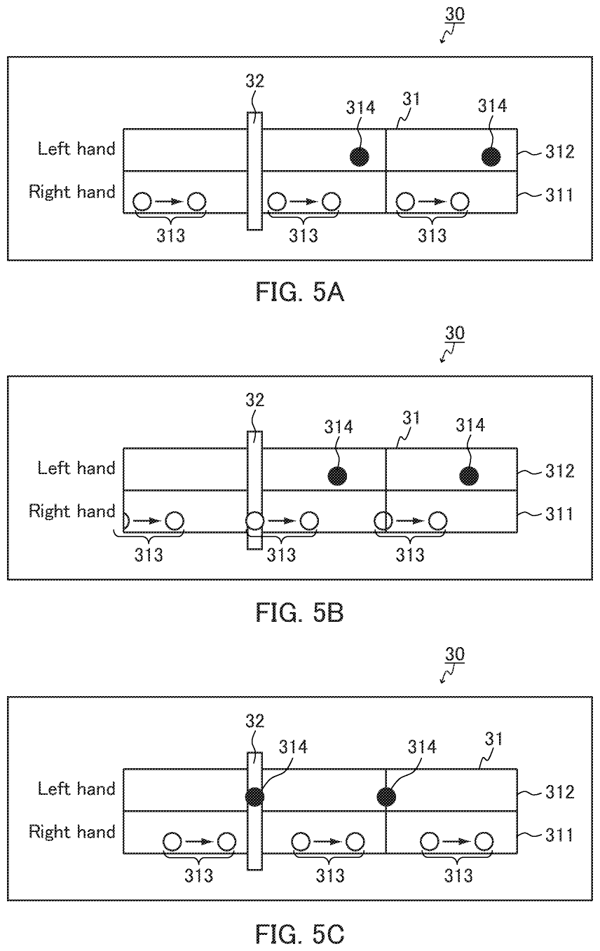

The display screen of the display system and the motion of the user who learns using the display screen are described with reference to FIG. 5. FIG. 5 shows an example of a display screen of the display system. As shown in FIG. 5A, a display screen 30 of the display system of the present example embodiment includes a note 31 and an instruction line 32. The note 31 includes a right-hand lane 311, a left-hand lane 312, and markers 313 and 314. FIG. 5B shows the display screen 30 after t₁ seconds from the display screen 30 shown in FIG. 5A and FIG. 5C shows the display screen 30 t₂ seconds from the display screen 30 shown in FIG. 5A. In the present example embodiment, the note 31 has the time axis direction in a left-to-right direction. The present invention, however, is not limited thereto, and the time axis direction in the display screen 30 can be any direction such as a right-to-left direction, a top-to-bottom direction, a bottom-to-top direction, or the like. In the present example embodiment, one type of marker is used for each of the marker 313 placed in the right-hand lane 311 and the marker 314 placed in the left-hand lane 312. The present invention, however, is not limited thereto, and as described above, two or more types of markers may be used for each of the markers 313 and 314.

The note 31 is a note in which the marker xₙ is placed at the execution time T_{Xn} in the time axis. In the present example embodiment, a fixed time range in the note 31 is displayed, and at this time, the starting point of the displayed fixed time range is moved from the start to the end of the note over time.

The instruction line 32 is a line for instructing the user to perform the motion corresponding to the marker 313 or 314 when the marker 313 or 314 overlaps with the line. The instruction line 32 may be referred to as a determination line, an evaluation line, or the like, for example, when the execution time Txₙ of the motion Xₙ corresponding to the marker xₙ is compared with the execution time of the motion of the user to determine or evaluate the motion of the user.

The right-hand lane 311 is a lane in which the marker 313 for indicating the motion to be performed by the right hand is placed. The marker 313 is a marker indicating the motion of grasping a predetermined object with the right hand, moving the object to a predetermined position, and then releasing the object.

The left-hand lane 312 is a lane in which the marker 314 indicating the motion to be performed by the left hand is placed. The marker 314 is a marker indicating the motion of pressing a predetermined button with the left hand.

Next, the motion of the user who learns using the display screen 30 is described with reference to FIG. 5. As described above, when the marker 313 or 314 overlaps with the instruction line 32, the user performs the motion corresponding to the overlapped marker 313 or 314. First, in FIG. 5A, there are no markers 313 and 314 overlapping with the instruction line 32. Thus, the user does not perform the right-hand and left-hand motions. Next, in FIG. 5B showing t₁ seconds after FIG. 5A, the marker 313 placed on the right-hand lane 311 overlaps with the instruction line 32. Thus, the user performs the motion of grasping a predetermined object with the right hand, moving the object to a predetermined position, and then releasing the object. Further, in FIG. 5C showing t₂ seconds after FIG. 5A, the marker 314 placed on the left-hand line 312 overlaps with the instruction line 32. Thus, the user performs the motion of pressing a predetermined button with the left hand. In this manner, the user can learn the motion of the target using the note 31.

### Fourth Example Embodiment

The program of the present example embodiment is a program that can execute the above-described display method on a computer. The program of the present example embodiment may be recorded on, for example, a computer-readable recording medium. The recording medium is not particularly limited, and examples thereof include random access memories (RAMs), read-only memories (ROMs), hard disks (HDs), optical disks, and floppy disks (FDs).

### Fifth Example Embodiment

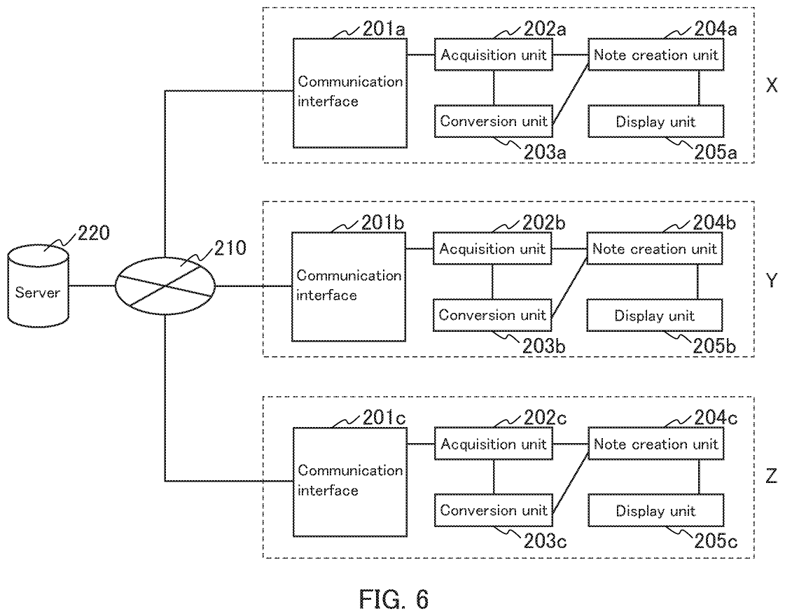

FIG. 6 shows an example configuration of the display system of the present invention. The display system of FIG. 6 shows an aspect in which the data storage unit and the other units of the display system of FIG. 1 are separately disposed in a server and a terminal, respectively. As shown in FIG. 6, the display system of the present example embodiment includes, for example, a server and a terminal, and the server and the terminal are connectable via a communication network outside the system. As shown in FIG. 6, the display system of the present example embodiment includes acquisition units 202a, 202b, and 202c, conversion units 203a, 203b, and 203c, note creation units 204a, 204b, and 204c, display units 205a, 205b, and 205c, communication interfaces 201a, 201b, and 201c, and a server 220. The acquisition unit 202a is connected to the communication interface 201a, the conversion unit 203a, and the note creation unit 204a, the conversion unit 203a is connected to the note creation unit 204a, and the note creation unit 204a is connected to the display unit 205a. The acquisition unit 202a, the conversion unit 203a, the note creation unit 204a, the display unit 205a, and the communication interface 201a are disposed at the location X. The acquisition unit 202b is connected to the communication interface 201b, the conversion unit 203b, and the note creation unit 204b, the conversion unit 203b is connected to the note creation unit 204b, and the note creation unit 204b is connected to the display unit 205b. The acquisition unit 202b, the conversion unit 203b, the note creation unit 204b, the display unit 205b, and the communication interface 201b are disposed at the location Y. The acquisition unit 202c is connected to the communication interface 201c, the conversion unit 203c, and the note creation unit 204c, the conversion unit 203c is connected to the note creation unit 204c, and the note creation unit 204c is connected to the display unit 205c. The acquisition unit 202c, the conversion unit 203c, the note creation unit 204c, the display unit 205c, and the communication interface 201c are disposed at the location Z. The communication interfaces 201a, 201b, and 201c are connected to the server 220 via a network 210.

In this display system, the data storage unit is stored in the server 220. For example, when the acquisition unit 202a requests the motion information of the target over time, the server 220 transmits the motion information of the target over time, for example, the acquisition unit 202a acquires the motion information of the target over time at the location X, the conversion unit 203a converts the motion Xₙ into the corresponding marker xₙ, the note creation unit 204a creates the note, and the display unit 205a displays the note.

According to the display system of the present example embodiment, as described above, the user can easily learn the motion of the target. The display system of the present example embodiment may be compatible with the second example embodiment, Variation 1, Variation 2, or a combination thereof. In the display system of the present example embodiment, the communication interfaces 201a, 201b, and 201c and the server 220 may be connected via a wireless network.

The present example embodiment shows an aspect in which the locations X, Y, and Z are each provided with one terminal. The present invention, however, is not limited thereto, and a plurality of terminals may be provided in one location. Furthermore, the present example embodiment shows an aspect in which the data storage unit is stored in a server and the other units are disposed in a terminal. The present invention, however, is not limited thereto, and any one or more units may be stored in the server and the other units may be disposed in the terminal. As a specific example, the data storage unit, the acquisition unit, the conversion unit, and the note creation unit may be stored in the server, and the display unit may be disposed in the terminal.

The invention of the present application was described above with reference to the example embodiments. However, the invention of the present application is not limited to the above-described example embodiments. Various changes that can be understood by those skilled in the art can be made in the configurations and details of the invention of the present application within the scope of the invention of the present application.

This application claims priority from Japanese Patent Application No. 2016-121106 filed on Jun. 17, 2016. The entire subject matter of the Japanese Patent Application is incorporated herein by reference.

### INDUSTRIAL APPLICABILITY

According to the present invention, the motion of a target over time can be learned easily. Thus, for example, the present invention is very useful in the field of learning of work know-how in a factory or the like.

### REFERENCE SIGNS LIST

10, 20 display system
11 data storage unit
12 data processing unit
121 acquisition unit
122 conversion unit
123 note creation unit
124 analysis unit
13 display unit
30 display screen
31 note
311 right-hand lane
312 left-hand lane
313, 314 marker
32 instruction line
201a, b, c communication interface
202a, b, c acquisition unit
203a, b, c conversion unit
204a, b, c note creation unit
205a, b, c display unit
210 communication network
220 server

What is claimed is:

1. A display system comprising a storage, at least one processor and a display, wherein:
the storage is configured to contain motion information of a target over time;
the processor is configured to acquire predetermined n types of motions Xₙ and execution times T_{Xn} of the motions Xₙ in a time axis from the motion information of the target over time;
convert the motion Xₙ into a corresponding marker xₙ; and
create a note in which the marker xₙ is placed at the execution time T_{Xn} in the time axis; and
the display is configured to display the note.

2. The display system according to claim 1, wherein the motion information of the target over time is motion data of the target.

3. The display system according to claim 2, further comprising:
the processor is configured to analyze the predetermined n types of motions Xₙ and the execution times T_{Xn} of the motions Xₙ in the time axis with reference to the motion data of the target, wherein
the processor is configured to acquire the predetermined n types of motions Xₙ and the execution times T_{Xn} analyzed by the analysis.

4. The display system according to claim 1, wherein the motion information of the target over time includes the predetermined n types of motions Xₙ and the execution times T_{Xn}.

5. The display system according to claim 1, further comprising:
the processor is configured to correct at least one selected from the group consisting of the number of markers xₙ, an interval between the markers xₙ, and a shape of the marker xₙ in the note.

6. The display system according to claim 1, wherein the display moves the note along the time axis and displays the marker xₙ at a predetermined position in the execution time T_{Xn}.

7. The display system according to claim 6, further comprising:
the processor is configured to control movement of the note in the display based on acquired motion information of a user.

8. A display method using motion information of a target over time, comprising:
acquiring predetermined n types of motions Xₙ and execution times T_{Xn} of the motions Xₙ in a time axis from the motion information of the target over time;
converting the motion Xₙ into a corresponding marker xₙ;
creating a note in which the marker xₙ is placed at the execution time T_{Xn} in the time axis; and
displaying the note.

9. The display method according to claim 8, wherein the motion information of the target over time is motion data of the target.

10. The display method according to claim 9, further comprising:
analyzing the predetermined n types of motions Xₙ and the execution times T_{Xn} of the motions Xₙ in the time axis with reference to the motion data of the target, wherein
the predetermined n types of motions Xₙ and the execution times T_{Xn} analyzed in the analysis step are acquired in the acquisition step.

11. The display method according to claim 8, wherein the motion information of the target over time includes the predetermined n types of motions Xₙ and the execution times T_{Xn}.

12. The display method according to claim 8, further comprising:
correcting at least one selected from the group consisting of the number of markers xₙ, an interval between the markers xₙ, and a shape of the marker xₙ in the note.

13. The display method according to claim 8, wherein the note is moved along the time axis, and the marker xₙ is displayed at a predetermined position in the execution time T_{Xn} in the display step.

14. The display method according to claim 13, further comprising:
controlling movement of the note in the display step based on acquired motion information of a user.

15. A non-transitory computer-readable storage medium comprising a program; wherein
the program is configured to execute the display method according to claim 8 on a computer.

16. (canceled)
